(19) United States
(12) Patent Application Publication
(10) Pub. No.: US 2014/0241541 A1
(43) Pub. Date: Aug. 28, 2014

(54) AUDIO SIGNAL ADAPTER DEVICE

(71) Applicant: Dongsheng Li, Beijing (CN)

(72) Inventor: Dongsheng Li, Beijing (CN)

(73) Assignee: Tendyron Corporation, Beijing (CN)

(21) Appl. No.: 14/106,293

(22) PCT Filed: Jun. 15, 2012
(86) PCT No.: PCT/CN2012/077037

§ 371 Date: Mar. 13, 2014

(30) Foreign Application Priority Data
Jun. 15, 2011 (CN) 201110161194.X

(51) Int. Cl. H04R 3/12

(52) U.S. Cl. CPC H04R 3/12; H04R 2499/11
USPC 381/74

(57) ABSTRACT

An audio signal adapter device is provided, comprising: an input port, an output port, and a signal amplifier, in which the input port is a headphone interface, and comprises a first audio signal input pin configured to receive an audio signal sent by an audio signal sending equipment and to output the audio signal to an input end of the signal amplifier; the output port comprises an audio signal output pin; and the signal amplifier is connected with the first audio signal input pin, an output end of the signal amplifier is connected with the audio signal output pin for outputting an amplified audio signal.

### FIELD

The present invention generally relates to an electronic technique field, and more particularly relates to an audio signal adapter device.

### BACKGROUND

With the development of an audio signal coding/decoding technology, more and more electronic equipments transmitting data via an audio interface are produced. For example, the electronic equipment can be connected with a mobile communication device via a low-resistance voice coil type of loudspeaker interface (such as a headphone interface) of the mobile communication device (such as a mobile phone) for receiving an audio signal output from the mobile communication device.

As an output power of the low-resistance voice coil type of loudspeaker interface is usually very low, except the electronic equipment (such as a headphone) with low power consumption, the electronic equipment receiving the audio signal via the low-resistance voice coil type of loudspeaker interface generally needs to use an external power source or an internal battery for normal working, which increases a cost of the electronic equipment and enlarges a volume of the electronic equipment.

### SUMMARY

The present disclosure provides an audio signal adapter device with a high output power.

The present disclosure provides an audio signal adapter device, comprising: an input port, an output port, a boosting unit, a rectifying unit and a filtering unit, wherein the input port comprises a first audio signal input pin configured to receive an audio signal sent by an audio signal sending equipment and to output the audio signal to an input end of the boosting unit; the boosting unit is configured to boost the audio signal input from the input end of the boosting unit, and to output a boosted audio signal to an input end of the rectifying unit via an output end of the boosting unit; the rectifying unit is configured to rectify the boosted audio signal input from the input end of the rectifying unit to obtain a level, and to output the level to an input end of the filtering unit via an output end of the rectifying unit; and the filtering unit is configured to filter the level input from the input end of the filtering unit to obtain a direct current level, and to output the direct current level to a power supply output pin of the output port via an output end of the filtering unit.

Furthermore, the output port comprises an audio signal output pin connected with the output end of the boosting unit and configured to output the audio signal.

Furthermore, the output port comprises an audio signal output pin connected with the first audio signal input pin and configured to output the audio signal.

Furthermore, the input port further comprises a MIC pin configured to output a signal to the audio signal sending equipment connected with the MIC pin.

Furthermore, the boosting unit is a boosting transformer, comprising a primary coil and a secondary coil; one pin of the primary coil is used as the input end of the boosting unit and connected with the first audio signal input pin, and the other pin of the primary coil is grounded; and at least one output pin of the secondary coil is used as the output end of the boosting unit and connected with the input end of the rectifying unit, and a tap of the secondary coil is grounded.

Furthermore, the rectifying unit comprises at least one diode, an anode of the at least one diode is connected with the input end of the rectifying unit, and a cathode of the at least one diode is connected with the output end of the rectifying unit.

Furthermore, the secondary coil of the boosting transformer comprises two output pins; the input end of the rectifying unit comprises two input pins; the two output pins of the secondary coil are connected with the two input pins of the rectifying unit respectively; and the rectifying unit comprises two diodes, and anodes of the two diodes are connected with the two input pins of the rectifying unit respectively.

Furthermore, the filtering unit comprises a capacitor; one end of the capacitor is connected with the input or output end of the filtering unit; and the input end of the filtering unit is connected with the output end of the filtering unit.

Furthermore, the audio signal adapter device further comprises a signal amplifier, and the audio signal output pin is connected with the output end of the boosting unit via the signal amplifier.

Furthermore, the audio signal adapter device further comprises a signal amplifier, and the audio signal output pin is connected with the first audio signal input pin via the signal amplifier.

Furthermore, the first audio signal input pin comprises a left-channel pin and a right-channel pin.

Furthermore, the boosting unit is a boosting transformer, comprising a primary coil and a secondary coil; one pin of the primary coil is used as the input end of the boosting unit and connected with the first audio signal input pin, and the other pin of the primary coil is grounded; and one output pin of the secondary coil is used as the output end of the boosting unit and connected with the input end of the rectifying unit, and the other output pin of the secondary coil is grounded.

Furthermore, the rectifying unit comprises one diode, an anode of the diode is connected with the input end of the rectifying unit, and a cathode of the diode is connected with the output end of the rectifying unit.

Furthermore, the input port further comprises a second audio signal input pin; the output port comprises an audio signal output pin; and the audio signal output pin is connected with the second audio signal input pin and configured to output the audio signal.

Furthermore, the audio signal adapter device further comprises a signal amplifier, and the audio signal output pin is connected with the second audio signal input pin via the signal amplifier.

In conclusion, the embodiments of the present disclosure realize feeding function via an audio signal with a relatively low hardware cost. An electronic equipment (an audio signal receiving equipment), used in combination with the audio signal adapter device (e.g., an audio cable or an audio adapter) of the present disclosure, can obtain power while receiving an audio signal, which reduces a cost of the electronic equipment and decreases a volume of the electronic equipment.

### BRIEF DESCRIPTION OF THE DRAWINGS

FIG. 1 is a schematic diagram of an audio signal adapter device according to a first embodiment of the present disclosure;

FIG. 2 is a schematic diagram of an audio signal adapter device according to a second embodiment of the present disclosure;

FIG. 3 is a schematic diagram of an audio signal adapter device according to a third embodiment of the present disclosure;

FIG. 4 is a schematic diagram of an audio signal adapter device according to a fourth embodiment of the present disclosure; and

FIG. 5 is a schematic diagram of an audio signal adapter device according to a fifth embodiment of the present disclosure.

### DETAILED DESCRIPTION

The present disclosure will be described below in detail with reference to drawings and embodiments.

The audio signal adapter device of the present disclosure may be an audio cable, an audio adapter cable, an audio adapter et. al.

### First Embodiment

FIG. 1 is a schematic diagram of an audio signal adapter device according to a first embodiment of the present disclosure. As shown in FIG. 1, the audio signal adapter device comprises a loudspeaker interface, a boosting unit (such as a boosting transformer shown in FIG. 1), a rectifying unit, a filtering unit, a power supply output pin (such as a VCC pin shown in FIG. 1) and an audio signal output pin.

The loudspeaker interface connected with an audio signal sending equipment (such as a mobile phone) is configured to receive an audio signal output from the audio signal sending equipment.

The loudspeaker interface may be a low-resistance voice coil type of loudspeaker interface (such as a headphone interface), comprising: an audio signal input pin (such as an AUDIO pin shown in FIG. 1), and a ground pin (such as a GND pin shown in FIG. 1).

Furthermore, the loudspeaker interface may comprise a MIC pin configured to output a signal to the audio signal sending equipment connected with the MIC pin.

The audio signal input pin of the loudspeaker interface connected with one pin of a primary coil of the boosting transformer is configured to receive the audio signal sent by the audio signal sending equipment (such as the mobile phone) and to output the audio signal to the one pin of the primary coil. The ground pin of the loudspeaker interface is grounded.

Alternatively, in order to reduce a power consumption of the audio signal sending equipment, a resistor R2 (not shown in FIG. 1) may be connected in series between the audio signal input pin and the boosting transformer.

The boosting transformer comprises the primary coil and a secondary coil, and is configured to raise an input voltage (commonly about 1V) at an input end (the primary coil) to an output voltage (for example, larger than or equal to 5V) at an output end (the secondary coil).

The primary coil of the boosting transformer has two pins, one pin is connected with the audio signal input pin of the loudspeaker interface, and the other pin is grounded.

The output coil (i.e. the secondary coil) of the boosting transformer has two output pins and one tap, the two output pins are connected with two input pins of an input end of the rectifying unit respectively, and the tap is grounded.

The rectifying unit has the input end and an output end, and is configured to rectify an alternating current level input from the input end thereof, and to output the rectified level via the output end thereof.

In this embodiment, the rectifying unit has two input pins of the input end, and one output pin of the output end. Accordingly, the rectifying unit comprises two diodes, positive poles of the two diodes are connected with the two input pins of the rectifying unit respectively, and negative poles of the two diodes are connected with the output pin of the rectifying unit.

The filtering unit has an input end and an output end, and is configured to convert the rectified level input from the input end to a smooth direct current level, and to output the smooth direct current level via the output end.

In this embodiment, the input end of the filtering unit is connected with the output end of the rectifying unit, and the output end of the filtering unit is used as (or connected with) the power supply output pin to supply power to an electronic equipment connected with the filtering unit or a function module of the electronic equipment.

In this embodiment, the input end and the output end of the filtering unit are connected, and the filtering unit comprises a capacitor C1, one end of which is connected with the input/output end of the filtering unit, and the other end of which is grounded.

Furthermore, in this embodiment, the audio signal output pin connected with one output pin of the output coil of the boosting transformer is configured to output the audio signal.

Alternatively, a signal amplifier may be connected between the audio signal output pin and the output pin of the output coil of the boosting transformer, that is, an input end of the signal amplifier is connected with one output pin of the output coil of the boosting transformer, and an output end of the signal amplifier is used as (or connected with) the audio signal output pin to output an amplified audio signal. As shown in FIG. 1, in this embodiment, the signal amplifier comprises a resistor R1 and an NPN-type triode. One end of the resistor R1 is connected with the input end of the signal amplifier, the other end of the resistor R1 is connected with a base (B) of the NPN-type triode, a collector (C) of the NPN-type triode is connected with the output end of the signal amplifier, and an emitter (E) of the NPN-type triode is grounded.

Alternatively, the signal amplifier comprises a resistor R1 and a PNP-type triode. One end of the resistor R1 is connected with the input end of the signal amplifier, the other end of the resistor R1 is connected with a collector (C) of the PNP-type triode, a base (B) of the PNP-type triode is connected with the output end of the signal amplifier, and an emitter (E) of the PNP-type triode is grounded.

### Second Embodiment

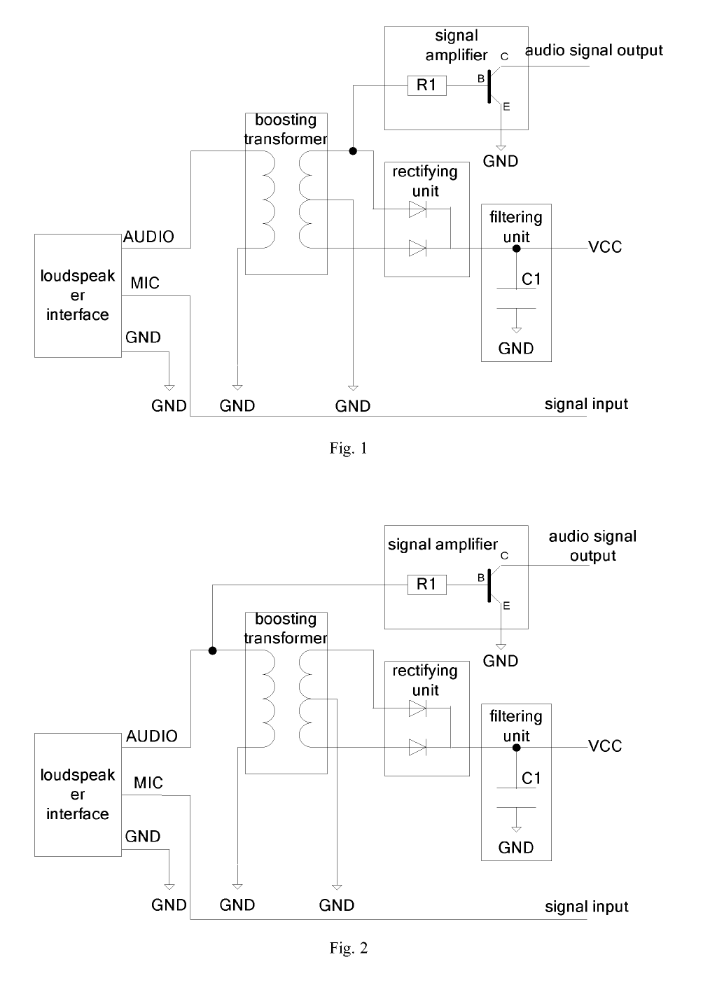

FIG. 2 is a schematic diagram of an audio signal adapter device according to a second embodiment of the present disclosure. As shown in FIG. 2, the differences between the second embodiment and the first embodiment are as follows.

The audio signal output pin is connected with the audio signal input pin of the loudspeaker interface.

Alternatively, a signal amplifier may be connected between the audio signal output pin and the audio signal input pin of the loudspeaker interface, that is, an input end of the signal amplifier is connected with the audio signal input pin, and an output end of the signal amplifier is used as (or connected with) the audio signal output pin to output an amplified audio signal.

### Third Embodiment

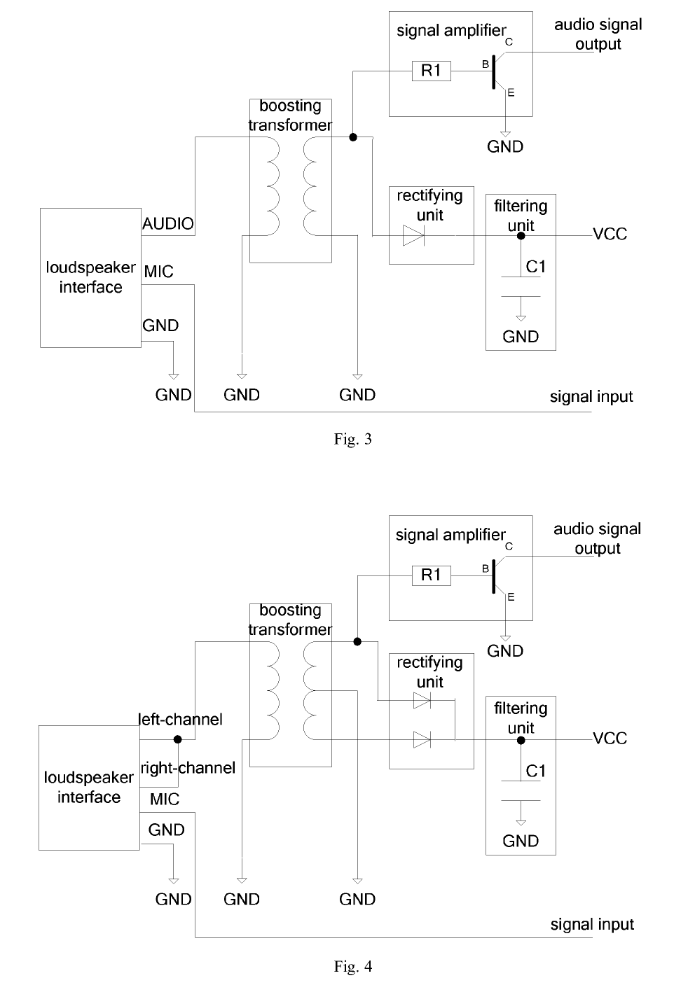

FIG. 3 is a schematic diagram of an audio signal adapter device according to a third embodiment of the present disclosure. As shown in FIG. 3, the differences between the third embodiment and the first embodiment are as follows.

In the third embodiment of the present disclosure, only one output pin of the secondary coil of the boosting transformer is connected with the input pin of the rectifying unit. Thus, the rectifying unit has only one input pin and comprises only one diode.

Apparently, compared with the first embodiment, by using this embodiment, although a half power of the secondary coil of the boosting transformer will be lost, a circuit structure may be simplified and a hardware cost may be reduced.

In this embodiment, the other output pin of the secondary coil of the boosting transformer is grounded, and a tap is not included in the boosting transformer.

### Fourth Embodiment

FIG. 4 is a schematic diagram of an audio signal adapter device according to a fourth embodiment of the present disclosure. As shown in FIG. 4, the differences between the fourth embodiment and the first embodiment are as follows.

In the fourth embodiment, the audio signal input pin of the loudspeaker interface comprises a left-channel pin and a right-channel pin, which are connected with the same pin of the primary coil of the boosting transformer.

### Fifth Embodiment

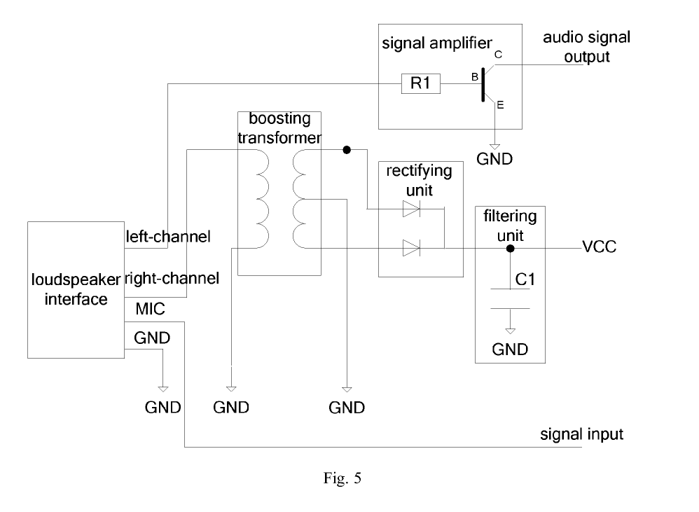

FIG. 5 is a schematic diagram of an audio signal adapter device according to a fifth embodiment of the present disclosure. As shown in FIG. 5, the differences between the fifth embodiment and the fourth embodiment are as follows.

In the fifth embodiment, the audio signal input pin of the loudspeaker interface comprises a left-channel pin and a right-channel pin. The left-channel pin connected with the input end of the signal amplifier is configured to output an audio signal, and the right-channel pin connected with one pin of the primary coil of the boosting transformer is configured to output power.

Certainly, alternatively, the right-channel pin connected with the input end of the signal amplifier is configured to output an audio signal, and the left-channel pin connected with one pin of the primary coil of the boosting transformer is configured to output power.

The embodiments of the present disclosure realize feeding function via an audio signal with a relatively low hardware cost. An electronic equipment, used in combination with the audio signal adapter device of the present disclosure, can obtain power while receiving an audio signal, which reduces a cost of the electronic equipment and decreases a volume of the electronic equipment.

Certainly, according to a basic principle of the present disclosure, the loudspeaker interface in above embodiments may be replaced by other types of input ports having an audio signal input pin, a MIC pin and a ground pin.

Furthermore, the above input port may be fixedly connected with the audio signal sending equipment.

Furthermore, the above output port may be fixedly connected with the electronic equipment (the audio signal receiving equipment).

The above input port may comprise a plurality of plugs, such as an audio signal plug comprising the audio signal input pin and a MIC plug comprising the MIC pin.

1. An audio signal adapter device, comprising: an input port, an output port, and a signal amplifier, wherein:
the input port is a headphone interface, and comprises a first audio signal input pin configured to receive an audio signal sent by an audio signal sending equipment and to output the audio signal to an input end of the signal amplifier;
the output port comprises an audio signal output pin; and
the signal amplifier is connected with the first audio signal input pin, an output end of the signal amplifier is connected with the audio signal output pin for outputting an amplified audio signal.

2. (canceled)

3. (canceled)

4. The audio signal adapter device according to claim 1, wherein the input port further comprises a MIC pin configured to output a signal to the audio signal sending equipment connected with the MIC pin.

5-15. (canceled)

16. The audio signal adapter device according to claim 1, further comprising:
a boosting unit, a rectifying unit and a filtering unit, wherein the boosting unit is configured to boost the audio signal input from an input end of the boosting unit, and to output a boosted audio signal to an input end of the rectifying unit via an output end of the boosting unit;
the rectifying unit is configured to rectify the boosted audio signal input from the input end of the rectifying unit to obtain a level, and to output the level to an input end of the filtering unit via an output end of the rectifying unit; and
the filtering unit is configured to filter the level input from the input end of the filtering unit to obtain a direct current level, and to output the direct current level to a power supply output pin of the output port via an output end of the filtering unit.

17. The audio signal adapter device according to claim 16, wherein
the boosting unit is a boosting transformer, comprising a primary coil and a secondary coil;
one pin of the primary coil is used as the input end of the boosting unit and connected with the first audio signal input pin, and the other pin of the primary coil is grounded; and
at least one output pin of the secondary coil is used as the output end of the boosting unit and connected with the input end of the rectifying unit, and a tap of the secondary coil is grounded.

18. The audio signal adapter device according to claim 16, wherein the rectifying unit comprises at least one diode, an anode of the at least one diode is connected with the input end of the rectifying unit, and a cathode of the at least one diode is connected with the output end of the rectifying unit.

19. The audio signal adapter device according to claim 17, wherein
the secondary coil of the boosting transformer comprises two output pins;
the input end of the rectifying unit comprises two input pins;
the two output pins of the secondary coil are connected with the two input pins of the rectifying unit respectively; and
the rectifying unit comprises two diodes, and anodes of the two diodes are connected with the two input pins of the rectifying unit respectively.

20. The audio signal adapter device according to claim 16, wherein
the filtering unit comprises a capacitor;
one end of the capacitor is connected with the input or output end of the filtering unit; and
the input end of the filtering unit is connected with the output end of the filtering unit.

21. The audio signal adapter device according to claim 1, wherein the first audio signal input pin comprises a left-channel pin and/or a right-channel pin.

22. The audio signal adapter device according to claim 4, wherein the first audio signal input pin comprises a left-channel pin and/or a right-channel pin.

23. The audio signal adapter device according to claim 16, wherein the first audio signal input pin comprises a left-channel pin and/or a right-channel pin.

24. The audio signal adapter device according to claim 17, wherein the first audio signal input pin comprises a left-channel pin and/or a right-channel pin.

25. The audio signal adapter device according to claim 18, wherein the first audio signal input pin comprises a left-channel pin and/or a right-channel pin.

26. The audio signal adapter device according to claim 19, wherein the first audio signal input pin comprises a left-channel pin and/or a right-channel pin.

27. The audio signal adapter device according to claim 20, wherein the first audio signal input pin comprises a left-channel pin and/or a right-channel pin.
